(19) United States
(12) Patent Application Publication
(10) Pub. No.: US 2016/0333842 A1
(43) Pub. Date: Nov. 17, 2016

(54) PRIMING SYSTEM FOR GASEOUS FUEL POWERED ENGINES

(71) Applicant: Caterpillar Inc., Peoria, IL (US)

(72) Inventors: Ryan Thomas Sunley, Washington, IL (US); William Wai Lam Fung, Peoria, IL (US); Lee David Kress, Lafayette, IN (US); Edward Thayer King, Peoria, IL (US); Joseph Paul Fuller, Morton, IL (US); Joshua Annin, Lafayette, IN (US); Jeffrey Richard Nudd, Chillicothe, IL (US)

(73) Assignee: Caterpillar Inc., Peoria, IL (US)

(21) Appl. No.: 14/711,696

(22) Filed: May 13, 2015

(51) Int. Cl. F02N 19/00; F02B 63/04

(52) U.S. Cl. CPC F02N 19/001; F02B 63/04

(57) ABSTRACT

A priming system for an engine system having a throttle valve configured to regulate a flow of air and fuel into an intake manifold of an engine is disclosed. The priming system may include a first sensor configured to generate a signal indicative of an engine speed, an auxiliary fuel line configured to direct fuel from a fuel source to a location between an outlet of the throttle valve and the intake manifold, an auxiliary fuel valve disposed in the auxiliary fuel line, and a controller in communication with the first sensor and the auxiliary fuel valve. The controller may be configured determine the engine speed based on the first signal and close the auxiliary fuel valve when the engine speed is greater than or equal to a threshold engine speed. The threshold engine speed may be less than an idle speed of the engine.

### TECHNICAL FIELD

The present disclosure relates generally to a priming system and, more particularly, to a priming system for gaseous fuel powered engines.

### BACKGROUND

Gaseous fuel powered engines are common in many applications. For example, the engine of an engine generator set (genset) can be powered by natural gas or another gaseous fuel. Natural gas may be more abundant and, therefore, less expensive than alternative fuels. Natural gas may also burn cleaner in some applications. During power outages, natural gas may be readily supplied to genset engines for extended periods of time via a direct connection to a gas utility, or over limited periods of time and in mobile applications via one or more associated storage tanks.

One problem associated with gaseous fuel powered engines is that a greater amount of time may be needed to initially start gaseous fuel powered engines as compared to engines powered by other types of fuel, such as diesel fuel. In particular, whereas diesel fuel may be supplied directly to combustion chambers of the engine, gaseous fuel may normally be supplied to the engine's intake system upstream of an associated compressor, so that the fuel needs to traverse a substantial portion of the intake system before reaching a combustion chamber of the engine. This may be problematic for gaseous fuel powered engines that drive gensets, where it may be desirable to minimize the amount of time between the loss of grid power and the provision of backup power, and/or where regulatory standards on genset startup times are applicable.

One example of a system for starting a gaseous powered engine is disclosed in U.S. Pat. No. 5,713,340 (the '340 patent) that issued to Vandenberghe et al. on Feb. 3, 1998. In particular, the '340 patent discloses a lower-pressure fuel source and a higher-pressure fuel source connected to an engine. The system determines whether the engine is being started based on the engine's speed, and delivers higher-pressure fuel directly to the engine from the higher-pressure fuel source. After the engine has started and a proper air/fuel ratio is achieved, the higher-pressure fuel supplied to the engine is reduced, and a supply of lower-pressure fuel is delivered to the engine from the lower-pressure fuel source during steady state operation.

While the system of the '340 patent may start a gaseous fuel powered engine, it may not be optimum. In particular, the system of the '340 patent may be too complex due to the use of multiple fuel storage vessels for providing multiple fuels streams at different pressures. Further, the starting ability of the system of the '340 patent may be limited by an amount of higher-pressure, fuel stored within the higher-pressure fuel source, and a need to replenish the higher-pressure fuel source. The system of the '340 patent may also be more costly to produce due to its complexity and additional fuel storage components.

The disclosed priming system is directed to overcoming one or more of the problems set forth above and/or other problems of the prior art.

### SUMMARY

In one aspect, the present disclosure is directed to a priming system for an engine system having a throttle valve configured to regulate a flow of air and fuel into an intake manifold of an engine. The priming system may include a first sensor configured to generate a signal indicative of an engine speed, an auxiliary Ethel line configured to direct fuel from a fuel source to a location between an outlet of the throttle valve and the intake manifold, an auxiliary fuel valve disposed in the auxiliary fuel line, and a controller in communication with the first sensor and the auxiliary fuel valve. The controller may be configured determine the engine speed based on the first signal and close the auxiliary fuel valve when the engine speed is greater than or equal to a threshold engine speed. The threshold engine speed may be less than an idle speed of the engine.

In another aspect, the present disclosure is directed to a method of priming a fuel system for an engine system having a throttle valve configured to regulate a flow of air and fuel into an intake manifold of an engine. The method may include supplying air and fuel to an inlet of the throttle valve, directing fuel from a fuel source to a location between an outlet of the throttle valve and the intake manifold via an auxiliary fuel line, determining an engine speed, and closing an auxiliary fuel valve disposed in the auxiliary fuel line when the engine speed is greater than or equal to a threshold engine speed. The threshold engine speed may be less than an idle speed of the engine.

In yet another aspect, the present disclosure is directed to a genset. The genset may include an electric generator and an engine system configured to drive the generator. The engine system may include an engine mechanically coupled to the generator and configured to combust a fuel from a fuel source to rotate the generator, a throttle valve having an inlet and an outlet and configured to regulate a flow of air and fuel to an intake manifold of the engine, a first sensor configured to generate a signal indicative of an engine speed, an auxiliary fuel line configured to direct fuel from the fuel source to a location between the outlet of the throttle valve and the intake manifold, an auxiliary fuel valve disposed in the auxiliary fuel line, and a second sensor configured to determine a pressure in the auxiliary fuel line at a location between the fuel source and the auxiliary fuel valve. The genset may further include a controller in communication with the first and second sensors and the auxiliary fuel valve. The controller may be configured to close the auxiliary fuel valve when the engine speed is greater than or equal to a threshold engine speed. The threshold engine speed may be less than an idle speed of the engine. The controller may be further configured to determine a previous position command of the auxiliary fuel valve, determine a desired position command for the auxiliary fuel valve based on the speed of the engine and the pressure in the auxiliary fuel line, and adjust the position of the auxiliary fuel valve based on the desired position command only when the desired position command is greater than the previous position command.

### BRIEF DESCRIPTION OF THE DRAWINGS

FIG. 1 is a side-view illustration of an exemplary disclosed genset;

FIG. 2 is a diagrammatic illustration of an engine with a fuel system and priming system that may be included in the genset of FIG. 1;

FIG. 3 is a flow chart of an exemplary priming process that may be used with the engine of FIG. 2; and

FIG. 4 is a flow chart of an exemplary valve adjustment process that may be used with the priming process of FIG. 3.

### DETAILED DESCRIPTION

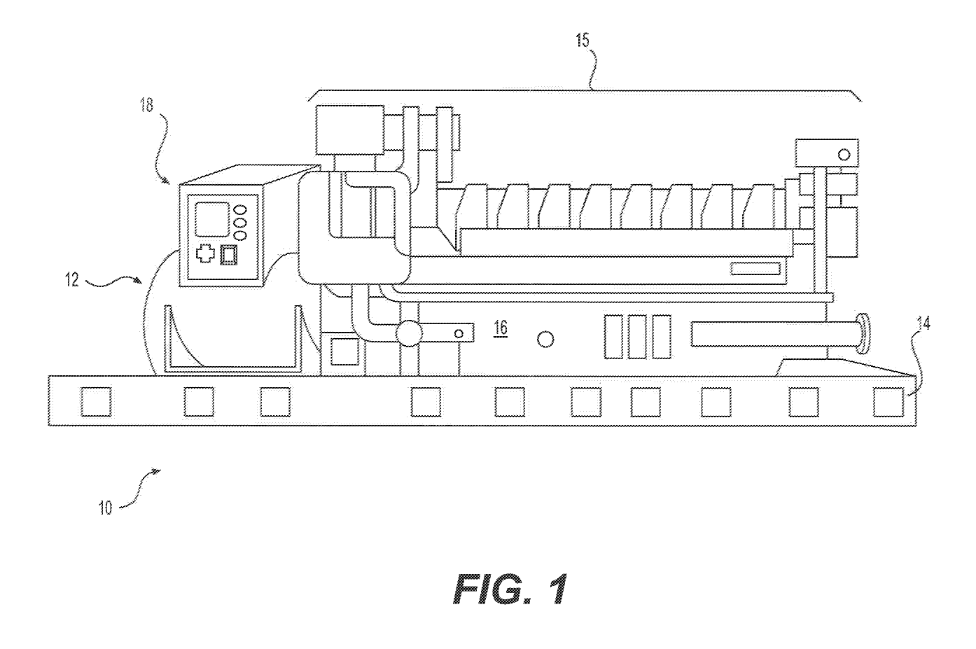

FIG. 1 illustrates a generator set (genset) 10 having an electric power generator 12 mounted to a frame 14, and an engine system 15 configured to drive generator 12. Engine system 15 may include an engine 16 mounted to frame 14 and coupled to mechanically rotate generator 12. Genset 10 may also include a controller 18 electronically connected to engine system 15. Engine system 15 may combust a fuel to generate a rotational mechanical output via engine 16, and generator 12 may convert the mechanical output of engine 16 into electrical power. Controller 18 may be configured to control various functions and operations engine system 15. Genset 10 may also include a separate generator controller (not shown) configured to control operations of generator 12. In some embodiments, controller 18 may control operations of both engine system 15 and generator 12. In other embodiments, genset 10 may include multiple controllers and/or control modules that are separately associated with engine system 15 and generator 12, respectively. Separate controllers may be in electronic communication and may interact and/or cooperate to perform their respective or shared control functions.

Generator 12 may be, for example, an alternating current (AC) induction generator, a permanent-magnet generator, an AC synchronous generator, a switched-reluctance generator, or another type of generator. In one embodiment, generator 12 may be configured to produce three-phase alternating current with a frequency of 50 and/or 60 Hz. It is contemplated, however, that generator 12 may be configured to produce single or two-phase power, and/or at another frequency, if desired. Generator 12 may also be configured to convert AC to direct current (DC) before delivering electricity to a consumer. Electrical power produced by generator 12 may be directed off-board to supplement grid power or to provide isolated consumers with electricity by way of one or more power lines and/or bus bars (not shown). Thus, genset 10 may be used as a backup power source or a primary power source. For example, if power from a primary power source is interrupted or stops being available, genset 10 may be used for backup power.

Engine 16 may be a combustion engine, for example, an internal combustion engine that burns a mixture of air and fuel to produce a mechanical power output. For the purpose of this disclosure, engine 16 is depicted as a gaseous fuel powered engine. For example, engine 16 may be configured to combust gaseous fuels, such as natural gas (compressed natural gas, liquid natural gas, etc.), biogas, coal gas, propane, butane, methane, hydrogen, or another fuel that is deliverable to engine 16 in a gas phase. It is contemplated, however, that engine 16 may also be fueled by other or additional types of fuel, such as diesel, biodiesel, or gasoline, if desired.

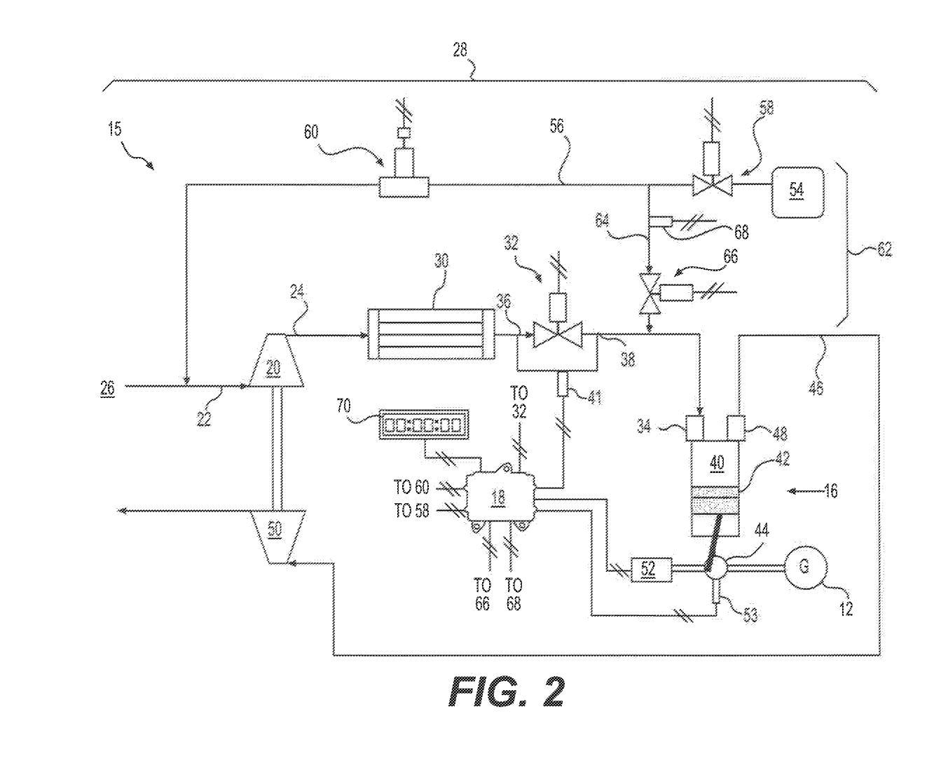

As shown in FIG. 2, engine system 15 may also include a compressor 20 having an inlet 22 and an outlet 24. Compressor 20 may be configured to draw air from an ambient air source 26 and receive fuel from a fuel system 28 via inlet 22, and produce a compressed mixture of air and fuel. For example, compressor 20 may include a plurality of vanes on a rotating disk (not shown) that is driven to draw air and fuel from inlet 22 and expel the compressed mixture through outlet 24. A cooling device, such as an aftercooler 30, may be fluidly connected downstream of outlet 24 to receive and cool the compressed mixture of air and fuel from compressor 20.

A throttle valve 32 may be configured to selectively pass the cooled compressed mixture from aftercooler 30 to an intake manifold 34. For example, throttle valve 32 may receive the compressed mixture through an inlet 36, and regulate passage of the mixture through an outlet 38 via a throttling device, such as a butterfly valve (not shown). Outlet 38 may be fluidly connected to intake manifold 34, where the mixture of air and fuel may be dispersed among one or more cylinders 40 (only one shown) of engine 16.

A sensor 41 may be associated with at least outlet 38 of throttle valve 32 and configured to determine a pressure, such as an absolute pressure, a gauge pressure, and/or a pressure differential Δₚ between inlet 36 and outlet 38. For example, sensor 41 may be a pressure differential sensor having two inlet ports, one being fluidly connected to inlet 36 and the other to outlet 38, and a diaphragm having a pressure sensing element between the two ports. The pressure sensing element may be a strain gauge, a capacitive sensor, a vibrating wire, or another device configured to sense a deflection of the diaphragm caused by the pressure differential Δₚ between inlet 36 and outlet 38. Sensor 41 may generate a signal indicative of the pressure differential Δₚ and communicate the signal to controller 18 for farther processing, in other embodiments, individual pressure sensors (e.g., gauge or absolute sensors) having a single port may be positioned on each side of throttle valve 32 (e.g., one near inlet 36 and another near outlet 38), and configured to independently determine a pressure value that controller 18 may use to determine pressure differential Δₚ.

A piston 42 may be disposed in each cylinder 40 of engine 16 and configured to reciprocate therein by forces produced when the mixture of air and fuel is ignited or otherwise caused to combust. Each piston 42 may be mechanically connected to a crankshaft 44 of engine 16 that is coupled to drive generator 12. Hot exhaust gases may be forced out of cylinders 40 by pistons 42 into an exhaust line 46 via an exhaust manifold 48 fluidly connected to cylinders 40.

A turbine 50 may be mechanically coupled to compressor 20, and fluidly connected to receive the hot exhaust gases from exhaust line 46 for recovering energy from the gases to drive compressor 20. For example, turbine 50 may include a plurality of vanes on a rotating disk (not shown) configured to absorb energy from the flow of the hot exhaust gases. Turbine 50 may be connected to compressor 20 via a shaft and transfer rotational mechanical energy to compressor 20 via the shaft. In other embodiments, compressor 20 may be driven independently from turbine 50 and may be driven by another device, such as an electric motor or crankshaft 44, if desired.

A starter 52 maybe mounted to engine 16 and configured to selectively engage and drive a rotational component of engine 16 during a starting process. Starter 52 may embody, for example, an electric starter motor having a solenoid configured to selectively engage a gear to the rotational component of engine 16, such as a flywheel, flex plate, or other component coupled to crankshaft 44. Starter 52 may be electronically connected to controller 18 and configured to receive a command generated by controller 18 to engage and drive engine 16 based on a startup signal received by controller 18. Upon receiving the command from controller 18, starter 52 may engage the rotational component and drive engine 16 until controller 18 ends the command, in other embodiments, starter 52 may embody a hydraulic starter, pneumatic starter, mechanical starter (e.g., spring-powered, crank-powered, etc.) or other type of starter.

Engine system 15 may also include a sensor 53 in communication with controller 18 and configured to generate a signal indicative of an engine speed N_{E} of engine 16. Sensor 53 may embody, for example, a magnetic pickup-type sensor in communication with a magnet embedded within a rotational component of engine 16, such as crankshaft 44, a flywheel, or the like. During operation of engine 16, sensor 53 may detect a rotating magnetic field produced by the embedded magnet and generate a corresponding feedback signal in response. The signal may have a frequency component directly proportional to the speed N_{E} of engine 16. Signals produced by sensor 53 may be indicative of an actual speed N_{E} of engine 16 and directed to controller 18 for further processing.

Fuel system 28 may be configured to receive fuel from a fuel source 54 and direct fuel to inlet 22 of compressor 20 via a fuel line 56. Fuel source 54 may be, for example, a fuel line directly connected to a gas utility (e.g., a natural gas utility), or one or more fuel storage containers (e.g., pressurized fuel tanks). Fuel within source 54 may be stored in a gaseous state, or stored in a liquid state and converted to a gaseous state before reaching cylinder 40.

A shutoff valve 58 may be disposed in fuel line 56 and fluidly connected between fuel source 54 and inlet 22 of compressor 20. Shutoff valve 58 may be a control valve in communication with controller 18, and configured to allow fuel to flow from source 54 to engine 16 via fuel line 56 when in an open position, and prevent the flow of fuel when in a closed position. That is, when in the open position, shutoff valve 58 may allow fuel to be directed to various locations within fuel system 28. Conversely, when in the closed position, shutoff valve 58 may entirely prevent fuel from passing to other locations within fuel system 28. Shutoff valve 58 may be moved to the open or closed position based on command signals from controller 18.

Fuel system 28 may also include a fuel metering valve 60 configured to receive fuel from source 54 and release controlled amounts of fuel into inlet 22 of compressor 20. Metering valve 60 may be fluidly connected to receive fuel from shutoff valve 58 and release controlled amounts of fuel to inlet 22 via fuel line 56. Metering valve 60 may also be in electronic communication with controller 18. Metering valve 60 may include an actuator configured to receive metering signals from controller 18 for controlling a mass-flow of fuel delivered to inlet 22 of compressor 20. For example, metering valve 60 may be a solenoid-operated control valve configured to receive metering signals from controller 18, and adjust a position of metering valve 60 via the associated solenoid to deliver more or less fuel to inlet 22 based on the signals from controller 18. It is understood that metering valve 60 may embody other types of valves and/or employ different types of automated and/or manual actuators.

Fuel system 28 may also include a priming system 62 configured to deliver fuel from fuel source 54 to intake manifold 34 without directing fuel to inlet 22 of compressor 20, thereby decreasing an amount of time needed to start engine 16. Priming system 62 may include an auxiliary fuel line 64 fluidly connected to fuel line 56 at a location between fuel source 54 and inlet 22 of compressor 20, e.g., between shutoff valve 58 and metering valve 60. Auxiliary fuel line 64 may be configured to direct fuel from source 54 to a location downstream of outlet 38 of throttle valve 32 via an auxiliary fuel valve 66. That is, auxiliary fuel line 64 may allow fuel from source 54 to bypass metering valve 60, compressor 20, aftercooler 30, and/or throttle valve 32, thereby providing a shorter path between fuel source 54 and intake manifold 34.

Auxiliary fuel valve 66 may be disposed in auxiliary fuel line 64 and fluidly connected between fuel line 56 and intake manifold 34. Auxiliary fuel valve 66 may be configured to selectively allow fuel to be delivered directly to intake manifold 34 via auxiliary fuel line 64 during a startup process of engine 16. For example, auxiliary fuel valve 66 may be a solenoid-operated proportional control valve in communication with controller 18. Auxiliary fuel valve 66 may be adjustable from a fully closed position through a range to a fully opened position, based on signals from controller 18. For example, controller 18 may be configured to determine a desired position command θ₁ and generate a signal to adjust auxiliary fuel valve 66 based on the desired position command θ₁. After a signal based on the desired position command is sent, controller 18 may store the command as previous position command θ₀, which may be used for further processing. In other embodiments, feedback position control of auxiliary fuel valve 66 may be used, which may include adjusting auxiliary fuel valve 66 based on determinations of a desired position and a previous position. Fuel that passes through auxiliary fuel valve 66 may traverse a shorter distance to reach intake manifold 34 than fuel passing through metering valve 60, and therefore may decrease the amount of time needed to start engine 16.

A sensor 68 may be associated with auxiliary fuel valve 66 and configured to generate a signal indicative of a pressure of fuel entering auxiliary fuel valve 66 from fuel line 56. Sensor 68 may be disposed in auxiliary fuel line 64 between fuel line 56 and auxiliary fuel valve 66 and may be in communication with controller 18. For example, sensor 68 may be a gauge or absolute pressure sensor, and include a diaphragm and a sensing element (e.g., strain gauge, capacitive sensor, vibrating wire, etc.) configured to sense a deflection of the diaphragm and generate a signal indicative of the pressure in auxiliary fuel line 64. Sensor 68 may communicate the signal to controller 18 for further processing.

Controller 18 may include computer-readable memory, such as read-only memory (ROM), random-access memory (RAM), and/or flash memory; secondary storage device(s), such as a tape-drive and/or magnetic disk drive; a microprocessor(s), a central processing unit CPU), and/or any other components for running control applications. The microprocessor(s) may comprise any suitable combination of commercially-available or specially-constructed microprocessors for controlling system operations in response to various sensors, including sensors 41, 53, 68, and/or operator inputs. Controller 18 may store instructions and/or data as hardware, software, and/or firmware within the memory, secondary storage device(s), and/or microprocessors. Various other circuits may be associated with controller 18, such as power supply circuitry, signal conditioning circuitry, solenoid driver circuitry, and other types of circuitry, if desired. As used herein, the term “in communication with” in regard to controller 18 may include sharing at least one data interface (e.g., via wired and/or wireless transmission hardware) and/or communicating data across at least one data interface. That is, being in communication may include being connected or connectable via a data interface, whether or not the interface is energized (i.e., transmitting data, standing by to transmit data, powered up, etc.).

Controller 18 may be configured to generate command signals based on various inputs, such as signals from sensors 41, 53, 68, operator inputs, and/or maps, tables, algorithms, models, etc., stored within its memory. For example, controller 18 may be configured to receive an automatically- or manually-generated startup signal, and open shutoff valve 58 and auxiliary fuel valve 66 based on the startup signal. The startup signal may, for example, be generated by an operator input (e.g., a key movement to a ‘start” position, pressing a button, selecting a startup mode, etc.), by a loss of primary grid power, by a computer, by an external power management system (e.g., a building or site power management system), or by a combination of these and/or other parameters. After receiving the startup signal, controller 18 may generate a command signal to open shutoff valve 58 and auxiliary fuel valve 66 in order to allow fuel to flow from fuel source 54 to intake manifold 34.

Controller 18 may also be configured to generate a command signal to selectively adjust a position of auxiliary fuel valve 66 based on operating parameters, such as a speed N_{E} of engine 16 and/or a pressure P_{F} in auxiliary fuel line 64. For example, using the signals from sensors 53 and 68, controller 18 may be configured to determine a desired position command θ₁ of auxiliary fuel valve 66 for achieving a desired fuel delivery rate into intake manifold 34 based on a map, table, algorithm, or other mathematical operation that correlates engine speed N_{E}, pressure P_{F} in auxiliary fuel line 64, and the position of auxiliary fuel valve 66.

Controller 18 may also be configured to generate a command signal to selectively close auxiliary fuel valve 66 and/or ensure auxiliary fuel valve 66 is closed based on one or more closing criteria. Ensuring auxiliary fuel valve 66 is closed may include checking and acknowledging that auxiliary fuel valve 66 is closed and/or closing auxiliary fuel valve 66 when auxiliary fuel valve 66 is open and one or more of the closing criteria has been achieved.

For example, controller 18 may be configured to ensure auxiliary fuel valve 66 is closed when the engine speed N_{E} is greater than or equal to a threshold engine speed N_{ET}. In some embodiments, the threshold engine speed N_{ET} may be an engine speed that indicates a successful startup of engine 16 has been achieved and/or that engine 16 is in a running condition. For example, achieving a stable idle speed (e.g., 600-800) RPM may indicate that engine 16 has successfully started and is in a running condition. It is understood that a different speed or range of speeds may be used to indicate that engine 16 has successfully started and is in a running condition, if desired.

In other embodiments, the threshold engine speed N_{ET} may be a speed at which engine 16 will successfully start up without further fueling from auxiliary fuel valve 66. This threshold engine speed N_{ET} may be less than an idle speed of engine 16. For example, achieving an engine speed between 350-400 RPM (inclusive) may allow engine 16 to successfully start without further fueling from auxiliary fuel valve 66 even though such a speed may be below an idle speed of engine 16. However, it is understood that the threshold engine speed N_{ET} at which engine 16 will start without further fueling from auxiliary fuel valve 66 may be higher or lower depending on the circumstances. For example, the threshold engine speed N_{ET} may be higher when the ambient temperature is lower (e.g., during colder weather), when an engine oil temperature is lower, etc. The threshold engine speed N_{ET} may be lower when the ambient temperature is higher (e.g., during warmer weather), when the engine oil temperature is higher, etc. The threshold engine speed N_{ET}may be higher or lower depending on other or additional parameters, such as humidity, altitude, an engine history parameter (e.g., a number hours ran), and/or other parameters.

Controller 18 may determine that the engine speed N_{E}, has reached the threshold engine speed N_{ET} based on signals from sensors (e.g., physical sensors, virtual sensors, etc.) and a map, algorithm, model, or other mathematical function stored within its memory. For example, a map may be generated using empirical testing under various conditions to correlate the threshold engine speed N_{ET} to one or more parameters (e.g., engine speed, ambient temperature, oil temperature, humidity, altitude, etc.). The map may be stored within the memory of controller 18, and controller 18 may be configured to determine the threshold engine speed N_{ET} by using the map in conjunction with one or more inputs, such as the engine speed N_{E} and/or one or more other parameters. The threshold engine speed may be single value or range of values stored within the memory of controller 18.

In some embodiments, the threshold engine speed N_{ET} may be a crank termination speed of engine 16. The crank termination speed may be an engine speed at which the starter is disengaged from engine 16. In one example, the threshold engine speed N_{ET} may be set to the crank termination speed. In another example, control logic for disengaging starter 52 from engine 16 may be stored in controller 18 or in another controller associated with genset 10, and this control logic may be used to close auxiliary fuel valve 66 at the same time that starter 52 is disengaged from engine 16. The crank termination speed may be an engine speed that is below an idle speed of engine 16, such as, for example, 350-400 RPM (inclusive). The crank termination speed may be higher or lower. For example, the crank termination speed may vary depending on the circumstances (e.g., ambient conditions, oil temperature, engine type, etc.), in this way, auxiliary fuel valve 66 may be closed as soon as fuel from auxiliary fuel line 64 is no longer needed.

Controller 18 may also be configured to ensure auxiliary fuel valve 66 is closed based on additional or other criteria, if desired. For example, controller 18 may be configured to ensure auxiliary fuel valve 66 is closed when the pressure differential Δₚ across inlet 36 and outlet 38 of throttle valve 32 exceeds a threshold Δ_{PT}. Ensuring auxiliary fuel valve 66 is closed may include closing auxiliary fuel valve 66 when auxiliary fuel valve 66 is open and the threshold Δ_{PT} has been exceeded. The pressure differential threshold Δ_{PT} may indicate that a starting process of engine 16 has been successful (e.g., that engine 16 is capable of running without assistance from starter 52) and engine system 15 may resume normal running operations (e.g., normal air/fuel control) without delivering fuel through auxiliary fuel line 64 via auxiliary fuel valve 66. Alternatively, the pressure differential Δₚ may be indicative of a likelihood that engine 16 will achieve a successful startup. For example, achieving the pressure differential threshold Δ_{PT} may indicate that engine 16 will successfully start without further fueling from auxiliary fuel valve 66, even though further assistance from starter 52 may be required.

For example, engine 16 may run at a faster rate as the startup process progresses, which may cause air and fuel to be drawn into intake manifold 34 from outlet 38 of throttle valve 32 at a higher flow rate. Accordingly, the air pressure downstream of throttle valve 32 may drop in response to the flow rate increase, and may cause the pressure differential Δₚ to exceed the threshold Δ_{PT}, When controller 18 determines that the pressure differential Δₚ has exceeded the threshold Δ_{PT} based on the signal from sensor 41, engine 16 may have been successfully started or has reached a condition where engine 18 will start without further fueling from auxiliary fuel valve 66. Controller 18 may have stored within its memory a map that correlates the pressure differential Δₚ with successful startups. The map may be generated based on empirical testing and may provide threshold pressure values or ranges of pressure values. The map may also correlate other parameters to the pressure differential threshold Δ_{PT}, such as ambient temperature, oil temperature, humidity, altitude, etc., and controller 18 may be configured to determine the pressure differential threshold based on operating conditions. The pressure differential threshold may be a single value or range of values stored within the memory of controller 18.

The pressure differential threshold Δ_{PT} may be obtained by measuring and recording the pressure differential Δₚ between inlet 36 and outlet 38 of throttle valve 32 when engine system 15 is determined to have completed the starting process, during one or more prior startups of engine 16. For example, the pressure differential threshold Δ_{PT} may be determined by correlating the differential pressure Δₚ with an engine parameter that may indicate that engine 16 has successfully started, such as engine speed, output torque, fuel consumption, etc., over one or more prior startups of engine 16. Based on the recorded differential pressure Δₚ value (or values), a desired pressure differential threshold Δ_{PT} may be determined.

For example, a successful startup may occur when engine 16 reaches an engine speed N_{E} of about 600-800 RPM, which may correspond to a pressure drop of about 15-25 kPa across throttle valve 32. Thus, the pressure differential threshold Δ_{PT} may be set to a value between about 15-20 kPa (e.g., about 15 kPa), or another value (e.g., a higher or lower value) at which engine 16 may be expected to have successfully started. Other ways of determining the differential pressure threshold Δ_{PT} may include selecting an average or median of several recorded pressure differential Δₚ values, or inputting the recorded values into an algorithm or model for determining a desired pressure differential threshold Δ_{PT}. Controller 18 may be configured to monitor the pressure differential Δₚ and close auxiliary fuel valve 66 when engine 16 has been successfully started, thereby reducing the overall startup time and improving the efficiency of engine 16.

Closing criteria may also include an elapsed time since a start command has been received by controller 18. For example, controller 18 may include a timer 70 configured to track a time elapsed since a beginning of a cranking state of engine 16. The beginning of a cranking state may occur, for example, when the engine speed N_{E} reaches a minimum speed (e.g., a non-zero speed), when shutoff valve 58 is first opened, or when a signal indicative of a desire to start engine 16 is received. Timer 70 may be embedded in controller 18 (e.g., an embedded function of controller 18) or may embody a timer in communication with controller 18. Timer 70 may produce an analog or digital signal indicative of the elapsed time, which may be communicated to controller 18 for further processing.

For example, the elapsed time indicated by timer 70 may be used by controller 18 to generate a command signal to selectively close auxiliary fuel valve 66. In some embodiments, controller 18 may be configured to ensure auxiliary fuel valve 66 is closed when the time elapsed exceeds an elapsed time limit T_{LIM}. The elapsed time limit T_{LIM} may be an amount of time that a startup process of engine 16 is allowed to last before controller 18 ends the startup process. Controller 18 may be configured to end the startup process when T_{LIM} is exceeded regardless of the pressure differential Δₚ between inlet 36 and outlet 38 of throttle valve 32 or any other criteria. For example, the elapsed time limit T_{LIM} may be selected based on an amount of time that auxiliary fuel valve 66 is allowed to be open without flooding engine 16 with fuel before the startup is successful. The elapsed time limit may also be selected based on regulatory limits on backup generator startup times for certain applications (e.g., backup power for hospitals). In one embodiment, the elapsed time limit T_{LIM} may be set to less than or equal to 10 seconds. It is understood, however, that the elapsed time limit T_{LIM} may be longer or shorter, if desired.

Controller 18 may also be configured to ensure auxiliary fuel valve 56 is closed whenever shutoff valve 58 is in a closed position. That is, controller 18 may be configured to close auxiliary fuel valve 66 and/or ensure auxiliary fuel valve 66 is closed whenever a command signal is generated to close shutoff valve 58. For example, whenever controller 18 generates a signal to close shutoff valve 58, controller 18 may send the same or a different signal to auxiliary fuel valve 66 to ensure auxiliary fuel valve 66 is closed when shutoff valve 58 is closed. A command signal to close shutoff valve 58 may be generated, for example, when any of the other closing criteria are satisfied. Command signals to close shutoff valve 58 may also be generated when a manual shutdown command is received from an operator, when a shutdown command is automatically generated by controller 18, or when controller 18 receives a shutdown command from an external source a return of primary grid power, a building or site power management system signal, etc.). In this way, controller may be configured to close auxiliary fuel valve 66 and/or ensure auxiliary fuel valve 66 is closed when shutoff valve 58 is closed, regardless of the other closing criteria.

### INDUSTRIAL APPLICABILITY

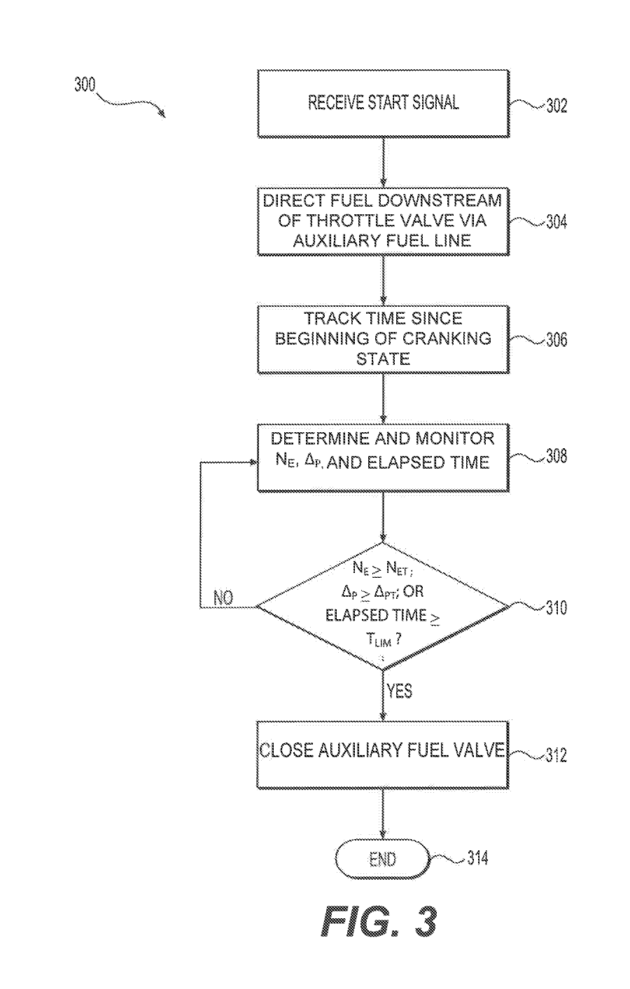

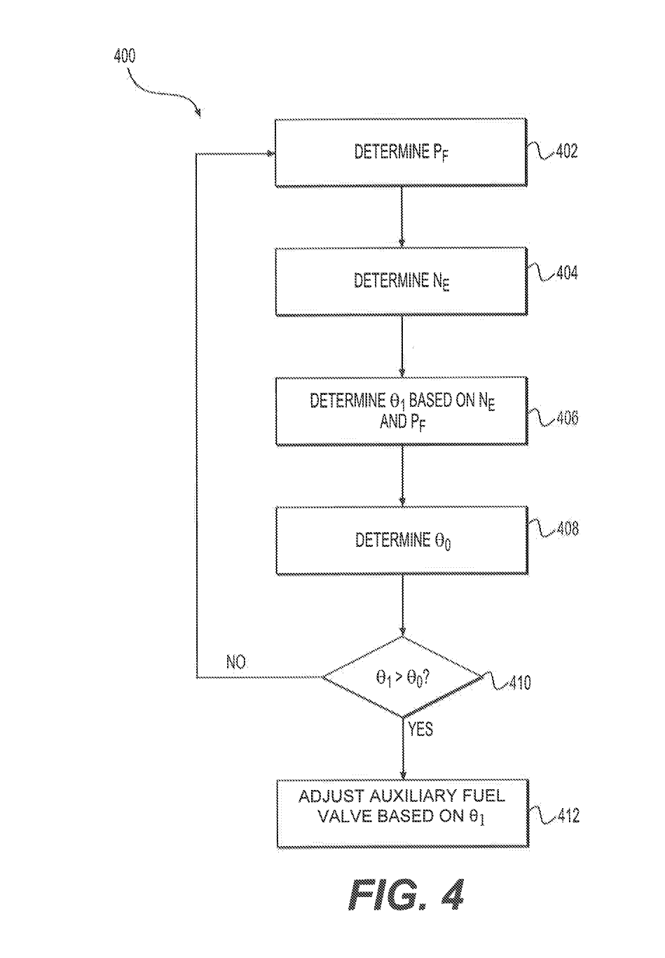

The disclosed priming system finds potential application in any system powered by a gaseous fuel powered engine, where it is desired to reduce the time taken to start the engine. The disclosed priming system has particular applicability in backup power generation applications, for example genset system applications having engines that burn natural gas fuel. One skilled in the art will recognize, however, that the disclosed priming system could be utilized with other gaseous fuel powered systems that may or may not be associated with a genset system. A process 300 of priming fuel system 28 with priming system 62 will now be explained with reference to FIGS. 3-4,

As shown in FIG. 3, priming process 300 may begin when controller 18 receives an engine startup signal indicative of a desire to start engine 16 (Step 302). The engine startup signal may be automatically or manually generated. For example, an automatically generated startup signal may be produced when grid power is lost. That is, controller 18 may be configured to receive a signal from a sensor, another controller, an external power management system, or otherwise determine that grid power to a consumer (e.g., a building, a stadium, a hospital, a plant, a piece of equipment, etc.) has been lost, and it is desired to start engine 16 in order to drive generator 12 to produce electrical power to supplement the lost grid power. A manually generated startup signal may be produced by an operator, for example, by turning a key associated with engine 16 to a “start” position, selecting a startup option or program via a user interface associated with controller 18, or by performing another type of manual startup procedure.

After the startup signal is received, fuel may be directed downstream of throttle valve 32 via auxiliary fuel line 64 (Step 304) to more quickly supply fuel to intake manifold 34 and allow engine 16 to start in less time. That is, based on the startup signal, controller 18 may open shutoff valve 58 to supply fuel to fuel system 28, and open auxiliary fuel valve 66 to supply fuel to priming system 62. In one embodiment, controller 18 may generate a command signal to open shutoff valve 58 based on the startup signal, and open auxiliary fuel valve 66 based the command signal used to open shutoff valve 58. It is understood, however, that auxiliary fuel valve 66 may be initially opened based on different and/or additional inputs, if desired. For example, controller 18 may open auxiliary fuel valve 66 when the engine speed N_{E} increases to a non-zero or other threshold speed, or when the differential pressure Δₚ increases to a non-zero or other threshold amount.

When auxiliary fuel valve 66 is open, a portion of fuel from source 54 may be allowed to circumvent metering valve 60, compressor 20, aftercooler 30, and throttle valve 32, thereby reducing the distance between fuel source 54 and intake manifold 34 and reducing the time taken for the portion fuel to reach intake manifold 34 as compared to fuel directed to inlet 22 of compressor 20. In this way, diverting a portion of fuel through auxiliary fuel line 64 and auxiliary fuel valve 66 may allow engine 16 to be started more quickly. Fuel may flow through auxiliary fuel line 64 and auxiliary fuel valve 66 while fuel is allowed to flow through metering valve 60, compressor 20, aftercooler 30, and throttle valve 32.

After receiving the startup signal, controller 18 may also track a time elapsed since a beginning of a cranking state of engine 16 (Step 306). For example, controller 18 may activate timer 70 once the startup signal is received and/or engine 16 reaches a minimum speed. Timer 70 may generate a signal indicative of the elapsed time and communicate the signal to controller 18. In other embodiments, controller 18 may alternatively activate an internal timer or timer function (i.e., timer 70 may be embedded within controller 18) after receiving the startup signal. Controller 18 may utilize the timer signal or store an indication of the elapsed time in its memory for further processing.

After receiving the startup signal, controller 18 may also determine and monitor the engine speed N_{E}, the pressure differential Δₚ between inlet 36 and outlet 38 of throttle valve 32, and the elapsed time (Step 308). It should be noted that steps 304-308 may be performed in the order shown, concurrently, or in any other order, if desired. Engine speed N_{E}, may be determined, for example, from the signal generated by sensor 53. The pressure differential Δₚ may be determined, for example, from the signal generated by sensor 41. Alternatively, controller 18 may be configured to determine Δₚ based on an absolute or gauge pressure sensor or other operating parameters, such as engine speed N_{E}, that are correlated in a lookup table or map stored in its memory.

As fuel flows through auxiliary fuel valve 66, controller 18 may monitor the engine speed N_{E}, the pressure differential Δₚ, and the elapsed time, and determine whether the engine speed N_{E} is greater than or equal to the threshold engine speed N_{ET}, whether the pressure differential Δₚ is greater than or equal to the threshold Δ_{PT}, or whether the elapsed time tracked by timer 70 is greater than or equal to the elapsed time limit T_{LIM} (Step 310). For example, controller 18 may compare the engine speed N_{E} to the threshold engine speed N_{ET}, which may be determined by controller 18 based on one or more parameters (e.g., ambient temperature, oil temperature, altitude, humidity, etc.) and/or based on a map, model, algorithm, or other mathematical function. Controller 18 may also compare the pressure differential Δₚ to the threshold Δ_{PT}, which may be stored in its memory as a pressure value in a map or table. Controller 18 may also compare the elapsed time tracked by timer 70 since receiving the startup signal in step 302 to the elapsed time limit T_{LIM}, which may be stored as a time value within its memory. When the statements in step 310 are false, controller 18 may determine that engine 16 may still require fuel from auxiliary fuel line 64 via auxiliary fuel valve 66, and may adjust the position of auxiliary fuel valve 66 based on current operating parameters (see FIG. 4).

Fuel may continue to be directed downstream of throttle valve 32 via auxiliary fuel valve 66 until controller 18 determines that at least one of the statements at step 310 is true or otherwise generates a signal to close shutoff valve 58 or auxiliary valve 66. When controller 18 determines that at least one of the statements at step 310 is true, controller 18 may determine that engine 16 no longer requires fuel from auxiliary fuel line 64 and may close auxiliary fuel valve 66 (Step 312). In this way, controller 18 may reduce the overall startup time and improving the efficiency of engine 16.

Controller 18 may also close auxiliary fuel valve 66 when a command signal is generated to close shutoff valve 58. That is, whenever controller 18 generates a signal to close shutoff valve 58, controller 18 may send the same or a different signal to auxiliary fuel valve 66 to ensure auxiliary fuel valve 66 is closed when shutoff valve 58 is closed. When in the closed position, shutoff valve 58 may prevent fuel from passing though fuel system 28 as well as priming system 62, and may be an indication that engine 16 is stopping or has stopped. Controller 18 may ensure auxiliary fuel valve 66 is closed when shutoff valve 58 is in the closed position. When controller 18 closes auxiliary fuel valve 66, process 300 may then be ended (Step 314).

FIG. 4 shows and exemplary valve adjustment process 400 that may be used to adjust auxiliary fuel valve 66. Controller 18 may begin adjustment process 400 by determining the fuel pressure P_{F} in auxiliary fuel line 64 (Step 402). For example, controller 18 may receive a signal from sensor 68 indicative of the pressure in auxiliary fuel line 64 at a location between fuel source 54 and auxiliary fuel valve 66. Because auxiliary fuel line 64 allows the fuel from source 54 to avoid metering valve 60 and compressor 20, the fuel pressure P_{F} in auxiliary fuel line 64 may be about equal to the pressure of fuel leaving shutoff valve 58. Accordingly, changes in fuel pressure leaving shutoff valve 58 may affect the fuel pressure P_{F} in auxiliary fuel line 64, and may affect the amount of fuel that can pass through auxiliary fuel line 64 for a given position of auxiliary fuel valve 66.

Controller 18 may also determine the speed N_{E} of engine 16 (Step 404). For example, controller 18 may receive a signal from sensor 53 indicative of the engine speed N_{E}. The engine speed N_{E} may be indicative of an amount of air being drawn into intake manifold 34 that can react with the fuel from auxiliary fuel line 64 via auxiliary fuel valve 66. In one embodiment, controller 18 may reference a table or map stored in its memory that correlates engine speed N_{E} with mass airflow. In other embodiments, engine 16 may include a mass airflow sensor, an oxygen sensor (e.g., a lambda sensor), or other type of sensor for determining the amount of air being drawn into intake manifold 34. It should be noted that step 404 may be performed after, before, or during step 402, if desired.

Based on the fuel pressure P_{F} and the engine speed N_{E}, controller 18 may determine a desired position command θ₁ of auxiliary fuel valve 66 (Step 406) that corresponds to achieving a desired air/fuel ratio during the startup of engine 16. For example, controller 18 may store in its memory a table or map that correlates the fuel pressure P_{F}, engine speed N_{E}, and air/fuel ratio with the desired position command θ₁ for achieving certain air/fuel ratios. In one embodiment, the maps and/or tables stored within controller 18 may be configured to achieve a stoichiometric air/fuel ratio during startup of engine 16. In other embodiments, the maps and/or tables may be configured to achieve a non-stoichiometric air/fuel ratio (e.g., a rich or lean air/fuel ratio) in order to achieve particular exhaust emissions or improve the startup time of engine 16. It is understood that controller 18 may include algorithms, models, and/or other computational elements as alternatives or in addition to the maps and/or tables for determining the desired position command θ₁ for adjusting auxiliary fuel valve 66.

Controller 18 may also determine the previous position command θ₀ of auxiliary fuel valve 66 (Step 408). For example, controller 18 may store in its memory the last position command that was generated and refer to it in step 408. Controller 18 may determine the previous position command θ₀ after, before, or during any of steps 402-406 if desired.

Controller may then compare the desired position command θ₁ of auxiliary fuel valve 66 to the previous position command θ₀ that was used to adjust the position of auxiliary fuel valve 66 (Step 410). When the desired position command θ₁ of auxiliary fuel valve 66 is greater than the previous position command θ₀ (Step 410: YES), controller 18 may generate a signal to adjust auxiliary fuel valve 66 based on the desired position command θ₁ (Step 412). That is, when the desired position command θ₁ will cause auxiliary fuel valve 66 to be adjusted to a more open position than the previous position command θ₀, controller 18 may adjust auxiliary fuel valve 66 based the desired position command θ₁. Conversely, when the desired position command θ₁ will not cause auxiliary fuel valve 66 to be adjusted to a more open than the previous position command θ₀, controller 18 may not adjust auxiliary fuel valve 66 based on the desired position command θ₁ and may return to step 402 without adjusting auxiliary fuel valve 66 (Step 410: NO). In this way, controller 18 may only allow auxiliary fuel valve 66 to be opened further (i.e., to a more open position) or remain in its previous position during the startup of engine 16.

Said another way, controller 18 may adjust auxiliary fuel valve 66 based on the desired position command θ₁ only when the desired position command θ₁ is greater than the previous position command θ₀. For example, controller 18 may be configured to adjust auxiliary fuel valve 66 to be more open as the pressure P_{F} in auxiliary fuel line 64 decreases in order to ensure a sufficient amount of fuel reaches intake manifold 34. Controller 18 may also be configured to adjust auxiliary fuel valve 66 to be more open as the engine speed N_{E} increases to ensure that the air/fuel mixture being sent to intake manifold 34 does not become too lean. However, controller 18 may not adjust auxiliary fuel valve 66 to a more closed position until the differential pressure Δₚ exceeds the differential pressure threshold Δ_{PT}, timer 70 exceeds the elapsed time limit T_{LIM}, or shutoff valve 58 is in the closed position Σ_{C}.

It will be apparent to those skilled in the art that various modifications and variations can be made to the priming system of the present disclosure. Other embodiments of the priming system will be apparent to those skilled in the art from consideration of the specification and practice of the priming system disclosed herein. It is intended that the specification and examples be considered as exemplary only, with a true scope being indicated by the following claims and their equivalents.

What is claimed is:

1. A priming system for an engine system having a throttle valve configured to regulate a flow of air and fuel into an intake manifold of an engine, the priming system comprising:
a first sensor configured to generate a signal indicative of an engine speed;
an auxiliary fuel line configured to direct fuel from a fuel source to a location between an outlet of the throttle valve and the intake manifold;
an auxiliary fuel valve disposed in the auxiliary fuel line; and
a controller in communication with the first sensor and the auxiliary fuel valve, wherein the controller is configured determine the engine speed based on the first signal, and close the auxiliary fuel valve when the engine speed is greater than or equal to a threshold engine speed, the threshold engine speed being less than an idle speed of the engine.

2. The priming system of claim 1, wherein the threshold engine speed is a crank termination speed of the engine.

3. The priming system of claim 2, wherein the threshold engine speed is between 350-400 RPM, inclusive.

4. The priming system of claim 1, wherein:
the priming system further includes a second sensor associated with the outlet of the throttle valve and configured to generate a signal indicative of a pressure differential between the outlet of the throttle valve and an inlet of the throttle valve; and
the controller is farther configured to close the auxiliary fuel valve based on the pressure differential.

5. The priming system of claim 4, wherein when the controller is configured to close the auxiliary fuel valve when the pressure differential exceeds a threshold.

6. The priming system of claim 5, wherein the controller is further configured to
track a time elapsed since a beginning of a cranking state of the engine; and
close the auxiliary fuel valve when the time elapsed exceeds an elapsed time limit.

7. The priming system of claim 6, wherein
the priming system further includes a shutoff valve between the fuel source and the auxiliary fuel valve; and
the controller is further configured to ensure the auxiliary fuel valve is closed when the shutoff valve is closed.

8. The priming system of claim 1, further including:
a second sensor configured to determine a pressure in the auxiliary fuel line at a location between the fuel source and the auxiliary fuel valve; and
the controller is further configured to adjust a position the auxiliary fuel valve based on a signal from the second sensor.

9. The priming system of claim 8, wherein the controller is further configured to adjust the position of the auxiliary fuel valve based on the speed of the engine.

10. The priming system of claim 9, wherein the controller is further configured to:
determine a previous position command of the auxiliary fuel valve;
determine a desired position command for the auxiliary fuel valve based on the speed of the engine and the pressure in the auxiliary fuel line; and
adjust the position of the auxiliary fuel valve based on the desired position command only when the desired position command is greater than the previous position command.

11. A method of priming a fuel system for an engine system having a throttle valve configured to regulate a flow of air and fuel into an intake manifold of an engine, the method comprising:
supplying air and fuel to an inlet of the throttle valve;
directing fuel from a fuel source to a location between an outlet of the throttle valve and the intake manifold via an auxiliary fuel line;
determining an engine speed; and
closing an auxiliary fuel valve disposed in the auxiliary fuel line when the engine speed is greater than or equal to a threshold engine speed, the threshold engine speed being less than an idle speed of the engine.

12. The method of claim 11, further including:
determining a pressure differential between an inlet of the throttle valve and an outlet of the throttle valve; and
closing the auxiliary fuel valve when the pressure differential exceeds a threshold.

13. The method of claim 12, wherein the method further includes:
tracking a time elapsed since a beginning of a cranking state of the engine; and
closing the auxiliary fuel valve when the time elapsed exceeds an elapsed time limit.

14. The method of claim 13, wherein:
the fuel system includes a shutoff valve between the fuel source and the auxiliary fuel valve; and
the method further includes ensuring the auxiliary fuel valve is closed when the shutoff valve is closed.

15. The method of claim 11, further including determining a fuel pressure in the auxiliary fuel line between the fuel source and the auxiliary fuel valve.

16. The method of claim 15, further including adjusting a position of the auxiliary fuel valve based on the fuel pressure.

17. The method of claim 16, wherein the position of the auxiliary fuel valve is adjusted based on the engine speed.

18. The method of claim 17, further including:
determining a previous position command of the auxiliary fuel valve; and
determining a desired position command of the auxiliary fuel valve based on the speed of the engine and the fuel pressure;
wherein the position of the auxiliary fuel valve is adjusted based on the desired position command only when the desired position command is greater than the previous position command.

19. The method of claim 11, wherein the threshold engine speed is a crank termination speed of the engine.

20. A genset comprising:
an electric generator;
an engine system configured to drive the generator and including:
an engine mechanically coupled to the generator and configured to combust a fuel from a fuel source to rotate the generator;
a throttle valve having an inlet and an outlet and configured to regulate a flow of air and fuel to an intake manifold of the engine;
a first sensor configured to generate a signal indicative of an engine speed;
an auxiliary fuel line configured to direct fuel from the fuel source to a location between the outlet of the throttle valve and the intake manifold;
an auxiliary fuel valve disposed in the auxiliary fuel line; and
a second sensor configured to determine a pressure in the auxiliary fuel line at a location between the fuel source and the auxiliary fuel valve; and
a controller in communication with the first and second sensors and the auxiliary fuel valve, wherein the controller is configured to:
close the auxiliary fuel valve when the engine speed is greater than or equal to a threshold engine speed, the threshold engine speed being less than an idle speed of the engine;
determine a previous position command of the auxiliary fuel valve;
determine a desired position command for the auxiliary fuel valve based on the speed of the engine and the pressure in the auxiliary fuel line; and
adjust the position of the auxiliary fuel valve based on the desired position command only when the desired position command is greater than the previous position command.
